(19) United States
(12) Patent Application Publication
(10) Pub. No.: US 2017/0130809 A1
(43) Pub. Date: May 11, 2017

(54) Positioning Unit

(71) Applicant: ANTON PAAR GMBH, GRAZ (AT)

(72) Inventor: NORBERT RATH, GRAZ (AT)

(73) Assignee: ANTON PAAR GMBH, GRAZ (AT)

(21) Appl. No.: 15/318,692

(22) PCT Filed: Jun. 10, 2015
(86) PCT No.: PCT/AT2015/050146

§ 371 Date: Dec. 14, 2016

(30) Foreign Application Priority Data
Jun. 24, 2014 (AT) A 50438/2014

(51) Int. Cl. F16H 25/20; B23Q 11/00; B23Q 5/40

(52) U.S. Cl. CPC F16H 25/20; B23Q 5/40; B23Q 11/0003; F16H 2025/204; F16H 2025/2075

(57) ABSTRACT

A positioning unit for a carriage is adjustable by way of a linear drive and a base. The linear drive has an elongate part and a short part. The positioning unit has two compensation rods. In each case two adjacent compensation rods are connected together at one end via a joint and are connected at the other end to the elongate part of the linear drive via one of two joint arrangements that are arranged in each case at the end of the elongate part. The compensation rods and the elongate part of the linear drive are arranged in the form of a triangle and the angle between the compensation rods and the joint is variable by a thermal change in length of the elongate part of the linear drive. The carriage is connected to the joint and the short part of the linear drive is connected to the base.

The present invention relates to a positioning unit for a carriage which is adjustable with a linear drive, according to the preamble of claim 1.

Linear drives generally comprise an elongate part and a short part, for example, in the case of spindle drives, a spindle and a nut which are movable with respect to each other and one of said parts is connected to a carriage. Furthermore, the prior art discloses linear drives with hydraulic or pneumatic adjustment devices having a cylinder and a piston with or without a piston rod, or linear motors. The positioning units with a linear drive are used, for example, for positioning carriages on which workpieces or samples are mounted or fastened for investigation. Positioning units of this type are also arranged and combined in the prior art in two or three directions of movement orthogonal to one another in order to permit 2- or 3-dimensional positioning.

During the operation of linear drives, for example spindle drives, by means of electric motors or other drives, the friction of the components and the heating of the drive, or external influences result in heating of the linear drive. Consequently, the components are also subject to heating and are subject to an expansion or change in length in accordance with the coefficients of thermal expansion of the materials used. In order to be able to accommodate or permit this change in length, this circumstance is taken into account in the prior art, for example in the case of spindle drives, in the mounting of the spindle. The spindle is thus provided with a movable bearing at one end and with a fixed bearing at the other end. The fixed bearing determines the position of the spindle along the axis of rotation, and the movable bearing permits the expansion of the spindle. The problem primarily associated therewith is that, in this way, during a heating of the spindle, the carriage which is connected to the spindle is moved from its intended position by an error distance. The size of the error distance and the associated deviating positioning is dependent on the position of the nut of the spindle drive with respect to the fixed bearing (the error distance value also increases at an increasing distance from the fixed bearing). For example, the position error of a spindle nut on a spindle with the length of 150 mm is up to 2.4 μm/° C. Such an erroneous positioning leads to an unacceptable error for example in the case of highly precise investigation in a scanning probe microscope or when manufacturing electric printed circuit boards.

The prior art discloses devices and methods for compensating for temperature-induced position errors in linear drives. In devices and methods known from the prior art, the heating of the linear drive is generally measured and the linear drive is repositioned by means of a previously determined model. Alternatively, as is customary in numerically controlled processing machines, a temperature-insensitive length measurement system, for example a glass scale, can be used in order to determine the actual position of the carriage. In that case, the linear drive can be positioned via a closed control circuit in such a manner that thermal drift is compensated for.

It is known from EP1170647 to determine a correction value for the thermal displacement on account of heat generation and heat conduction in a spindle drive of a machine tool and to correct the tool position on the basis of the correction value.

Furthermore, for example, JPH05208342 discloses an access drive motor with a position detector for a feed screw. A gap amount is detected with the aid of a gap sensor and measured with a detection device. The thermal displacement of the longitudinal direction of the feed screw is calculated on the basis of the measured displacement variable, a mechanical constant and the like, and the correction value for the position error is determined and the position of the feed screw corrected by a numerical control system.

However, “repositioning” required by the methods or devices known from the prior art causes the positioning unit or parts thereof to be heated again, which requires a further “repositioning” and heats the positioning unit again, etc. Similarly, during a subsequent cooling of the system, the position error is produced again by the shortening of the components, as a result of which renewed “repositioning” of the carriage is required, with further heating resulting therefrom. This circumstance brings about a continuous adjustment and “repositioning” of the carriage of the positioning unit, as a result of which an above all exact positioning of the components is made more difficult, if not even impossible.

Further methods known from the prior art can determine the displacement of the sample on the basis of thermal expansion/contraction of the linear drive—for example by means of a model-based approach which calculates the temperature distribution in the structure back to the change in length, or by the use of a suitable length measurement system, for example expensive glass scales, and the carriage can be approximately correctly positioned again with the aid of the linear drive. Apart from the high outlay on sensor technology which is required in order to detect position errors or temperature profiles, the activation of the drive signifies a dynamic intervention in the system with diverse negative consequences, such as shaking, excitation of vibration or positioning error due to stick slip effects. Such an intervention can be reflected, in the case of a measurement system, in the form of an artifact in the measurement result, and, in the case of a processing machine, as an undesirable surface structure. In addition, thermal drift in this way can only be eliminated if the deviation lies within the order of magnitude of the resolution of the linear drive.

It is therefore the object of the present invention to provide a device of the type mentioned at the beginning which minimizes or entirely avoids position errors due to thermal expansion of a linear drive.

This object is achieved by the characterizing features of claim 1. According to the invention, it is provided that the positioning unit has at least two compensation rods, wherein in each case two adjacent compensation rods are connected to each other at their one end via a joint and are connected at their other end in each case at the elongate part of the linear drive via one of two joint arrangements which are each arranged at the end of the elongate part of the linear drive, wherein the compensation rods and the elongate part of the linear drive are arranged in the form of a triangle, and the angle between the compensation rods is changeable at the joint by a thermal change in length of the elongate part of the linear drive, and wherein the carriage is connected to the joint and the short part of the linear drive is connected to the base, or the carriage is connected to the short part of the linear drive and the base is connected to the joint.

By means of the construction of the device with compensation rods and the joints and also the joint arrangements, a change in length of the linear drive leads to a change in the angle between the adjacent compensation rods which are connected via the joint. The angle becomes smaller during cooling and an associated shortening of the elongate part of the linear drive, and the angle becomes larger during heating or an increase in temperature and an associated lengthening of the elongate part of the linear drive. Stresses induced by the thermal expansion in the linear drive are thus prevented and at the same time the position error of a carriage fastened to the linear drive is compensated for. In the optimum case, with positioning in the center of the spindle, the compensation is compensated for completely and directly upon occurrence without the carriage having to be repositioned. Thus, a measurement of samples arranged on the carriage is possible in an interference-free manner or manufacturing can be carried out without interruption and without having to expect a transient response—positioning, heating, repositioning, cooling, renewed repositioning—after positioning.

Furthermore, a novel, compact and thermally stable, motorized positioning unit is produced which compensates for a thermal change in length of the components in a positioning unit and permits rapid and reliable positioning. Possibilities of using the motorized positioning unit in environments with great jumps in temperature are therefore possible without unacceptable drift movements arising due to the temperature changes. A positioning unit according to the invention is provided for the precise positioning of workpieces or for the positioning of samples for a microscope, a scanning probe microscope, a scanning force microscope, an electron microscope and the like.

Particularly advantageous embodiments of the device are defined in more detail by the features of the dependent claims:

In order to prevent the linear drive itself from having to receive loads other than those directed along the spindle axis, for example torques about axes transversely with respect to the spindle axis, a symmetrical construction is advantageous. It is provided here that four compensation rods are used, wherein in each case two adjacent compensation rods are connected at one end in each case via a joint and are connected at the other end in each case to the elongate part of the linear drive via one of the two joint arrangements which are each arranged at the end of the elongate part of the linear drive, wherein in each case the two compensation rods, which are connected via the joints, and the elongate part of the linear drive are arranged in the form of a triangle, and the angle between the two compensation rods, which are connected at the joints, is in each case changeable at the joints by a thermal change in length of the elongate part of the linear drive, wherein the four compensation rods are arranged in the form of a parallelogram, and wherein the carriage is connected to the joints and the short part of the linear drive is connected to the base, or the carriage is connected to the short part of the linear drive and the base is connected to the joints.

The elongate part of the linear drive is thus not subjected to a bending stress and the smooth running of the linear drive is guaranteed and also tilting of the carriage is prevented.

A particularly favorable arrangement and distribution of force in the compensation rods is achieved in that the two, in particular four, compensation rods have the same length and in each case the two compensation rods, which are connected via the joint, are arranged together with the elongate part of the linear drive in the form of an isosceles triangle, and in particular the four compensation rods are arranged in the form of a parallelogram.

An alternative embodiment is provided in that the two, in particular four, compensation rods have different lengths, preferably in pairs, and in each case the two compensation rods, which are connected via the joint, are arranged together with the elongate part of the linear drive in the form of a general triangle, and/or in particular the four compensation rods are arranged in the form of a general square.

The construction of the joint arrangement is simplified and the costs of a device according to the invention are thus reduced if the joint arrangements each have at least two partial joints, wherein each partial joint connects the joint arrangements to one compensation rod each.

The size of the device is reduced in that the joints, the joint arrangements and/or the partial joints are designed as solid joints.

The use of solid joints provides significant advantages over discrete joints. They can be realized in a manner free from play, in a manner free from friction, i.e. very substantially linear in their behavior, at reasonable cost and in a relatively small construction space.

The device can be configured to be particularly flat and the stresses are particularly effectively distributed in the device if the joints, the joint arrangements and the linear drive are arranged in a plane, wherein the joints are displaceable in said plane.

The rigidity of the positioning unit is increased if the compensation rods, the joints and/or the joint arrangements are realized in duplicate for a stiffer design and in each case in every two planes, which are in particular arranged parallel to each other, are arranged at a distance from the plane of movement of the linear drive, in particular in a mirrored arrangement about the linear drive.

The carriage is protected against rotation and jamming if the carriage is guided in at least one guide, in particular a cross roller guide. Furthermore, linear ball guides, aerostatic or hydrostatic linear guides are alternatively useable.

A preferred embodiment of the device is achieved if the linear drive is designed as a spindle drive, wherein the elongate part is designed as a spindle and the short part is designed as a nut moving on the spindle, wherein the compensation rods are each connected to one of the ends of the spindle via the joint arrangement, in particular to partial joints, and wherein the carriage is connected to the nut and the base is connected to the joint, in particular to the two joints, or the carriage is connected to the joint, in particular to the two joints, and the base is connected to the nut.

The change in the length of the spindle is accommodated particularly readily in the device if the spindle is in each case mounted in a bearing, in particular a fixed bearing, on the joint arrangements.

In the case of use of a one-sided, clamped bearing, a pretensioning has to be implemented in the system, ensuring that a structurally one-sided bearing nevertheless acts as a fixed bearing.

The connection to the carriage or the base can be improved if the device has springs, wherein in each case one spring connects one joint in each case to the carriage or to the base, and/or the joints are each pretensionable by springs.

The pretensioning furthermore permits a setting of the initial tension or initial pressure on the elongate part of the linear drive and the angle between the compensation rods connected via the joint to be changed.

A simple embodiment of the positioning unit is achieved in that the compensation rods and/or the joint arrangements are integrated in a, preferably flat, plate, in particular a metal plate, and are designed as said plate, wherein the joints and/or the partial joints, preferably in the plate, are designed as solid joints, in particular as webs connecting the compensation rods and/or the joint arrangements.

The plate is produced, for example, by punching, eroding or cutting out the plate from, for example, a metal plate by means of laser or other suitable manufacturing methods.

The rigidity of the positioning unit can be furthermore increased if at least two, in particular four, plates are provided, wherein the positioning unit is formed by two mutually parallel planes of joint structures each having two layers of plates.

A simple and slender embodiment of the positioning unit can be achieved in that the springs are designed as a parallelogram structure, wherein the parallelogram structures are integrated in the compensation rods, in particular in the plates.

The joints or the compensation rods can be connected to the carriage or to the base if the compensation rods have connection points, in particular arranged on the parallelogram structure, preferably in the region of the joints, wherein the connection points of a compensation rod together with the connection points of the compensation rod which is connected via the respective joint are in each case connected to the carriage or to the base via a connecting element.

In order to keep the heat input into the compensation structure low and to avoid local temperature gradients, it is provided that the linear drive, the joint arrangements and the compensation rods have good thermal coupling with respect to one another, for example via a suitable choice of material, such as, for example, identical materials or materials having suitable coefficients of heat conduction, and/or large contact surfaces are, however, very substantially thermally decoupled from the rest of the positioning unit, for example the carriage, the base and the motor, for example by small contact surfaces and the specific use of insulation layers, for example plastics layers or air gaps. In addition, the thermal mass of the compensation structure is kept consciously low, while the thermal mass of the components not determining the position is comparatively large. By means of the cooperation of these characteristics, heat which is introduced into the positioning unit is preferably distributed in the parts not determining the position. The small quantity of heat which nevertheless flows into the compensation structure via the thermal decoupling is distributed rapidly in the compensation structure because of the good thermal coupling and the low thermal mass and does not allow temperature gradients to arise virtually at all.

A positioning unit with a carriage which can be positioned 2-dimensionally is provided in that two positioning units and a respective linear drive assigned to the positioning units are provided, wherein the directions of movement of the carriages of the linear drives preferably run orthogonally to each other, and wherein one of the carriages is connectable to the base or to the carriage of the other positioning unit in each case.

A positioning unit with a carriage which can be positioned 3-dimensionally is provided in that a further positioning unit, for 3-dimensional positioning, is provided, wherein the further positioning unit is preferably arranged orthogonally to the two positioning units and is connectable to the base or to the carriage of one of the two positioning units.

Further advantages and refinements of the invention emerge from the description and the attached drawings.

The invention is illustrated schematically below in the drawings using particularly advantageous exemplary embodiments, which should not, however, be understood as being limiting, and is described by way of example with reference to the drawings:

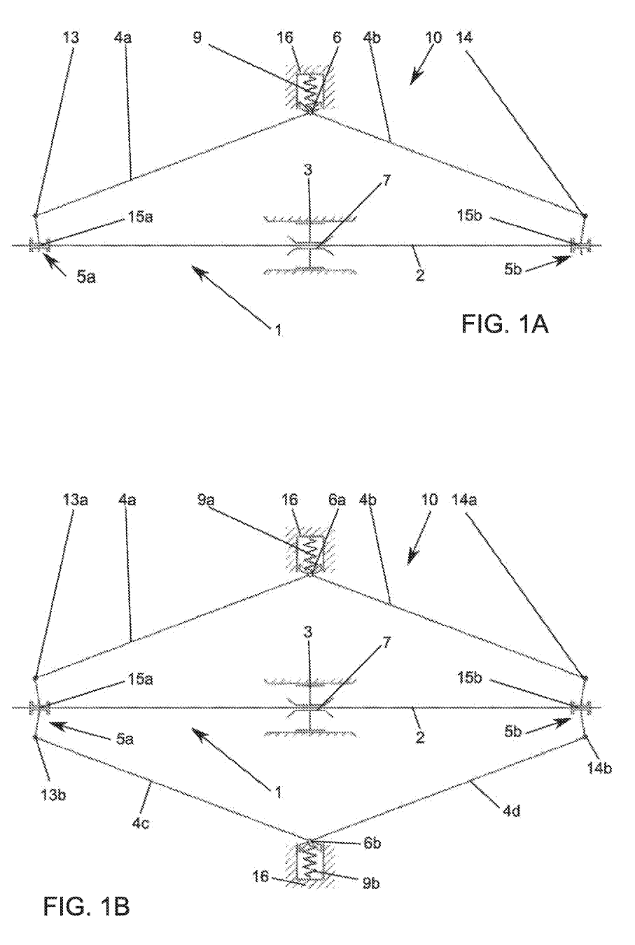

FIG. 1a shows a schematic view of an embodiment of the positioning unit according to the invention,

FIG. 1b shows a schematic view of an embodiment of the positioning unit according to the invention with four compensation rods,

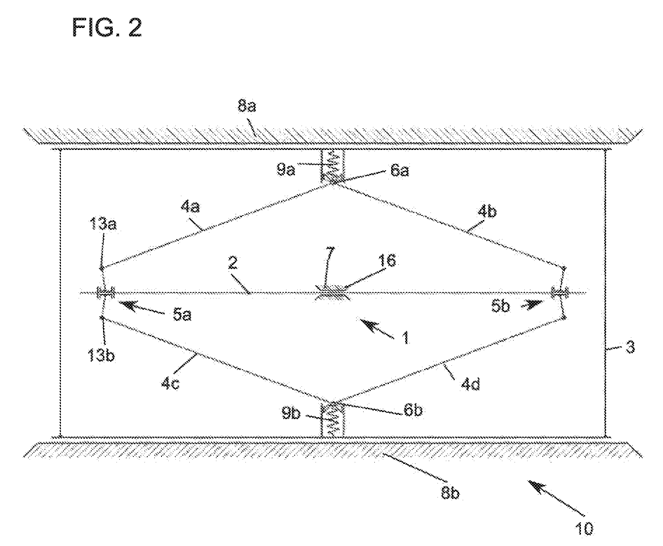

FIG. 2 shows a schematic view of an embodiment of the positioning unit according to the invention with a nut fastened to the reference system or with a nut fastened to the base,

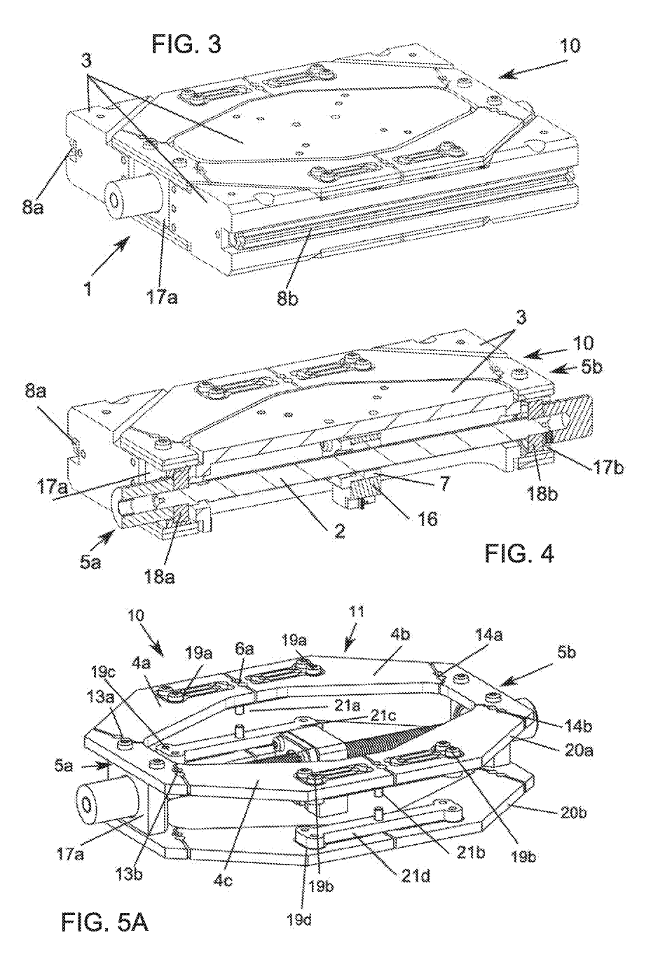

FIG. 3 shows an embodiment of a positioning unit according to the invention with a carriage in a perspective view,

FIG. 4 shows a perspective sectional view according to FIG. 3,

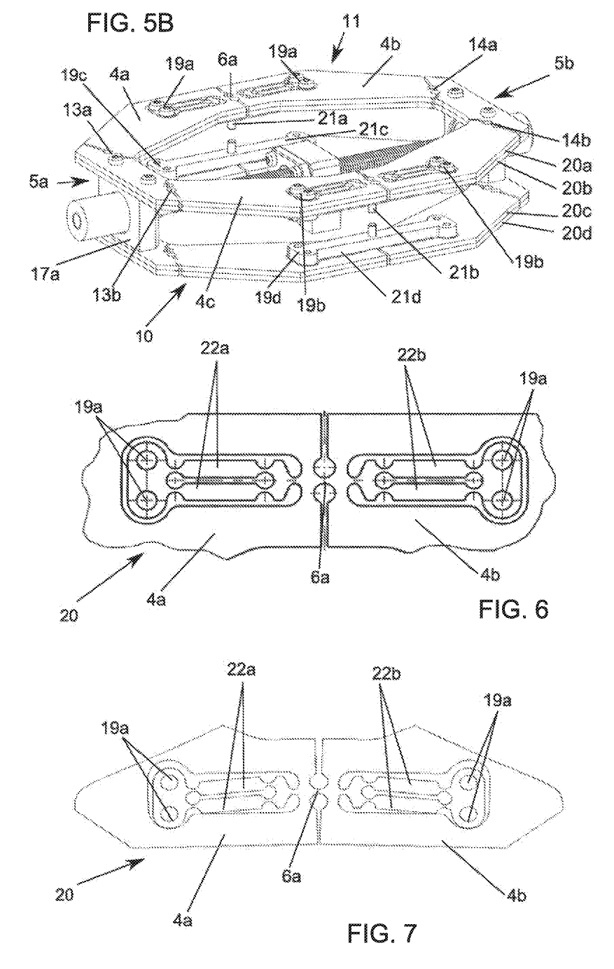

FIG. 5a shows a perspective view of an embodiment of the compensation structure of the positioning unit according to the invention,

FIG. 5b shows a perspective view of an embodiment of the compensation structure of the positioning unit according to the invention with four plates,

FIGS. 6 and 7 show a detailed view of an embodiment of joints in the undeformed and deformed state,

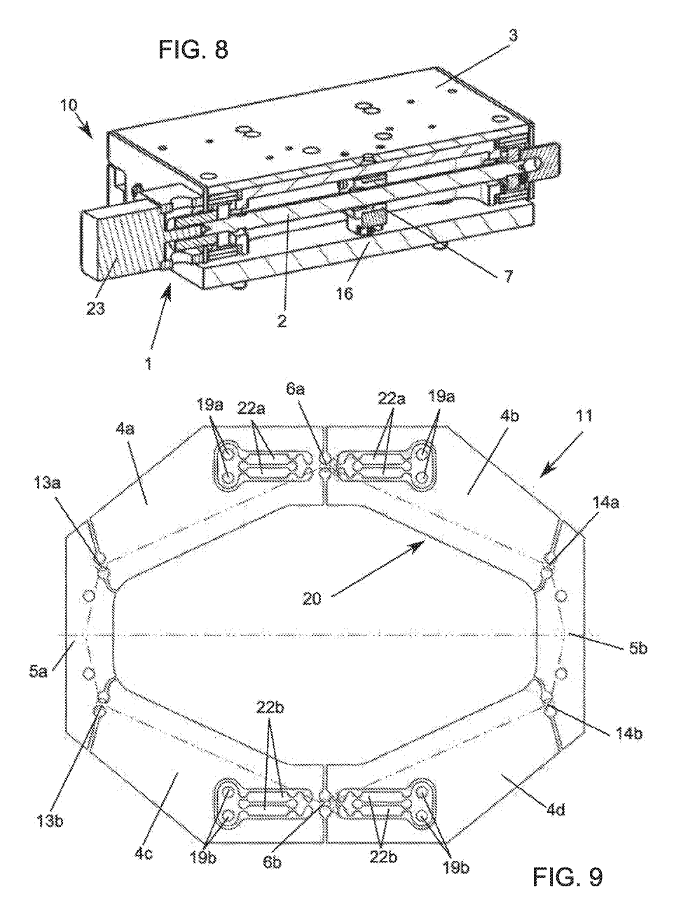

FIG. 8 shows a perspective sectional view of a positioning unit according to the invention,

FIG. 9 shows a basic outline of an embodiment of the device, and

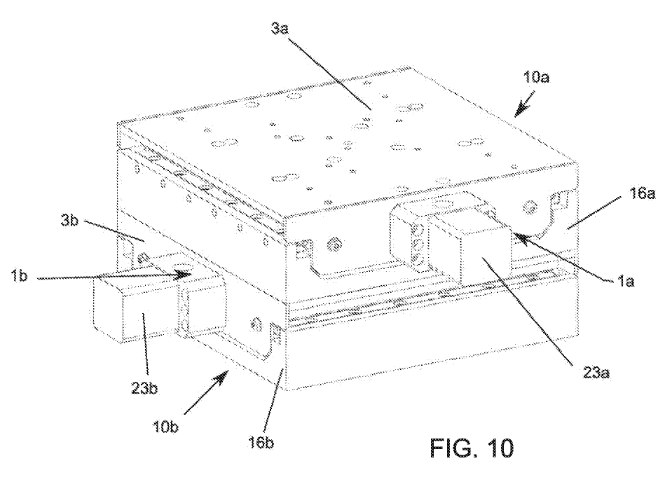

FIG. 10 shows an embodiment of the invention with two positioning units positioned orthogonally with respect to each other.

FIG. 1a shows an embodiment of the positioning unit 10 according to the invention with two compensation rods 4a and 4b which are connected via a joint 6 and are arranged in an isosceles triangle with a long part of a linear drive 1. This embodiment is explained analogously in the description of the figure for the embodiment of FIG. 1b.

FIG. 1b illustrates an embodiment of the positioning unit 10 according to the invention in a schematic view. The positioning unit 10 has a linear drive 1 comprising an elongate part and a short part. In this embodiment, the linear drive 1 is designed as a spindle drive, wherein the elongate part is a spindle 2 and the short part is a nut 7. The nut 7 sits on the spindle 2 and is fastened to a carriage 3. When the spindle 2 is rotated, the carriage 3 is moved by the nut 7 in a translatory manner along the spindle axis. The spindle 2 is mounted rotatably at its ends by means of two bearings 15a and 15b, in this embodiment by means of rolling bearings designed as fixed bearings, and is connected to the bearings 15a and 15b by a joint arrangement 5a and 5b in each case. The positioning unit 10 has a compensation structure 11 with four compensation rods 4a, 4b, 4c and 4d. Two of the adjacent compensation rods 4a, 4b, 4c and 4d, namely the compensation rods 4a and 4b, are connected to each other at one of their ends via a joint 6a in each case, in this embodiment, for example, a hinge joint, and are connected at their other end to the spindle 2 of the linear drive 1 in each case via the joint arrangement 5a and 5b. Analogously to the compensation rods 4a, 4b, the two further compensation rods 4c and 4d are likewise connected to each other at one of their ends, the adjacent end, via a joint 6b and are likewise fastened at the other end in each case to the joint arrangement 5a and 5b. The compensation rods 4a and 4b and the compensation rods 4c and 4d in each case together form a parallelogram. The compensation rods 4a and 4b and the compensation rods 4c and 4d in each case form an isosceles triangle together with the spindle 2 of the linear drive 1 via respective joints 6a and 6b. The joints 6a and 6b are each connected via a spring 9a, 9b to the base 16, i.e. to the frame of the positioning unit. The compensation rods 4a, 4b, 4c, 4d are connected to one another at the joints 6a and 6b in a rotatable manner by means of pivotable hinge joints and are mounted pivotably at the joint arrangement 5a, 5b, in each case on a partial joint 13a, 13b and 14a, 14b, in this embodiment likewise via a hinge joint. In addition to hinge joints, ball joints or other rotatable joints are also suitable for the joints 6a, 6b and the partial joints 13a, 13b and 14a, 14b and can be used analogously.

In the event of a thermally induced change in length of the spindle 2, the distance between the two joint arrangements 5a and 5b is increased. The compensation rods 4a, 4b, 4c, 4d are inclined via the joint arrangements 5a and 5b and the partial joints 13a, 13b and 14a, 14b and the joints 6a, 6b are displaced in the direction of the spindle 2 orthogonally with respect to the spindle axis. This furthermore brings about an increase in the angle between the compensation rods 4a and 4b or 4c and 4d. By means of the fastening of the joints 6a and 6b to the base 16, the change in length of the spindle 2 is not transmitted to the carriage 3 because of the change in the angle between the compensation rods 4a and 4b or 4c and 4d and the displacement of the joints 6a, 6b in the direction of the spindle 2, and the carriage 3 remains in its place. The springs 9a and 9b, which connect the joints 6a, 6b to the base 16, can have or apply a pretensioning for better setting of the distance between the joints 6a, 6b or in order to avoid a bearing play in the joint arrangements 5a and 5b. The springs 9a, 9b can also be replaced equivalently by pneumatic or controlled hydraulic cylinders or by other types of spring.

The embodiment illustrated in FIG. 2 has an analogous construction of the positioning unit 10 to the embodiment described in FIG. 1. However, the nut 7 is fixedly connected to the base 16, i.e. to the frame of the positioning unit 10 and to the reference system. In this embodiment, the carriage 3 is connected to the joints 6a, 6b via the springs 9a and 9b. In this arrangement, when the spindle 2 is rotated, the spindle 2, by means of the fixed nut 7, moves the compensation rods 4a, 4b, 4c, 4d, the joint arrangements 5a, 5b, the joints 6a, 6b and the carriage 3, which is connected to the joints 6a, 6b, in a translatory manner. For better guidance, the carriage 3 is guided and mounted on the two longitudinal sides via a respective guide 8a, 8b, for example cross roller guides.

FIG. 3 illustrates a further embodiment of the positioning unit 10 with the carriage 3 and the linear drive 1 in a perspective view. To this end, FIG. 4 shows the sectional view of this embodiment. The spindle 2 is rotated by a motor 23 (FIG. 8) and moves the spindle 2 relative to the nut 7 fastened to the base 16 or to the frame. The spindle 2 is mounted via rolling bearings 18a, 18b which are attached to both ends of the spindle 2. The inner ring of the rolling bearings 18a, 18b is clamped to a shaft shoulder of the spindle 2 and the outer ring is clamped in each case in a bearing shell 17a, 17b. The joint arrangements 5a, 5b act on the upper and lower side of the bearing shells 17a, 17b.

FIG. 5a illustrates the compensation structure 11 of the positioning unit 10 of the arrangement described in FIGS. 3 and 4. The compensation rods 4a, 4b, 4c, 4d are formed or integrated in two plates 20a and 20b, for example thin metal plates, together with the joint arrangements 5a, 5b. The bearing shells 17a, 17b are connected to the joint arrangements 5a, 5b. The entire compensation structure 11 is formed by two mutually parallel planes of joint structures with one of the plates 20a and 20b, wherein the two planes of the joint structures are arranged in a mirrored manner about the axis of the spindle 2 or in a mirrored manner with respect to the linear drive 1. This increases the rigidity between carriage 3 and base 16. In addition, the construction remains symmetrical in this way without the compensation structure 11 having to lie level with the spindle.

FIG. 5b shows a further embodiment of the compensation structure 11 of the positioning unit 10 with four plates 20a, 20b, 20c, 20d. The entire compensation structure 11 is formed by two mutually parallel planes of joint structures each having two layers of plates 20a, 20b, 20c, 20d adjacent to one another, wherein the two planes of the joint structures are arranged in a mirrored manner about the axis of the spindle 2 or in a mirrored manner with respect to the linear drive 1. The plates 20a, 20b, 20c, 20d are of identical design and lie one above another in a covering manner. The joints 6a, 6b and the partial joints 13a, 13b, 14a, 14b are designed as solid joints in the plates 20a, 20b, 20c, 20d (FIG. 9). The compensation rods 4a, 4b, 4c, 4d and the joint arrangements 5a, 5b are connected in an articulated manner by the joints 6a, 6b and partial joints 13a, 13b, 14a, 14b designed as solid joints, in this embodiment by webs formed in the plates 20a, 20b, 20c, 20d.

The plates 20a, 20b, 20c, 20d are self-contained and are connected to the base 16 via the nut 7. The plates 20a, 20b, 20c, 20d are connected to the carriage 3 via four pairs of connection points 19a, 19b, 19c, 19d. As illustrated in FIGS. 5a and 5b, the connection points 19a, 19b, 19c, 19d can be connected in pairs by means of connecting elements 21a, 21b, 21c, 21d via screws and only said connecting elements 21a, 21b, 21c, 21d are then connected to the carriage 3. Alternatively, the connection points 19a, 19b, 19c, 19d can be directly connected to the carriage 3.

When the spindle 2 expands, the mountings of the spindle 2 move together with the spindle 2, but the carriage 3 remains fixed in position. Analogously to the embodiment described in FIG. 2, the joints 6a, 6b and the partial joints 13a, 13b and 14a, 14b compensate for the expansion of the spindle 2 and therefore the carriage 3 and a possible sample to be investigated on the carriage 3 likewise remain fixed in position on the positioning unit 10. Alternatively, the construction is also possible in the reverse direction of operation with a moving nut 7 and a fixed spindle 2.

The connection points 19a, 19b, 19c, 19d and the springs 9a, 9b, 9c, 9d are likewise designed as solid joints or adapted to the solid joints. A detailed view of the connection points 19a, 19b is illustrated in the undeformed state in FIG. 6 and in the deformed state in FIG. 7. The joint 6a which is designed as a solid joint permits the relative tilting of the two compensation rods 4a, 4b with respect to each other and very substantially defines the pivot point of the tilting. The position of the pivot point in the orthogonal direction with respect to the spindle axis is defined on each of the two compensation rods 4a, 4b via a respective parallelogram structure 22a, the latter, in the installed position, permitting a very substantially straight movement transversely with respect to the spindle axis, but preventing a translation of the joints 6a, 6b along the spindle axis. The parallelogram structures 22a themselves are connected to the carriage 3 via the connection points 19a. If a pretensioning of the spindle 2 via the compensation rods 4a, 4b, 4c, 4d of the positioning unit 10 is desired, the connection points 19a, 19b, 19c, 19d can be tensioned in the direction of the spindle 2 or away from the spindle 2 over the course of the installation and can thus bring about an initial tension or pressure on the spindle 2.

If the carriage 3 and compensation structure 11 of the positioning unit 10 are composed of materials having different coefficients of thermal expansion, it is possible in each case to connect the connection points 19a, 19b, 19c, 19d of two compensation rods 4a, 4b, 4c, 4d first of all via connecting elements 21a, 21b, 21c, 21d which have the same coefficient of thermal expansion as the compensation structure 11 of the positioning unit 10, and to connect said connecting elements 21a, 21b, 21c, 21d to the carriage 3. In this way, temperature-induced stresses between the connection points 19a, 19b, 19c, 19d in the parallelogram structures 22a, 22b, 22c, 22d can be prevented. FIG. 7 shows a detailed view of the compensation rods 4a, 4b in the deformed state and the resulting deformation of the parallelogram structures 22a. The connection points 19a and the joint 6a are displaced here in the orthogonal direction with respect to the axis of the spindle 2, and a movement along the spindle axis is prevented.

FIG. 8 illustrates an embodiment of a positioning unit 10 according to the invention with a linear drive 1 and carriage 3. A drive, here a stepping motor 23, which produces the rotation of the spindle 2, is fastened to one end of the spindle 2. The nut 7 is fixedly connected to the base 16. A rotation of the spindle 2 brings about the displacement of the spindle 2 along the spindle axis and therefore the translation of the carriage 3 in the direction of the spindle axis.

FIG. 9 shows a top view of a plate 20, which is described in FIG. 5, with the compensation rods 4a, 4b, 4c, 4d, which are integrated in the plate 20 or in the metal plate, connection points 19a, 19b, joints 6a, 6b, joint arrangements 5a, 5b with partial joints 13a, 13b and 14a, 14b and parallelogram structures 22a, 22b.

A further embodiment of the device contains four compensation rods 4a, 4b, 4c, 4d which have different length dimensions in pairs, for example the compensation rods 4a and 4c or 4b and 4d can each have different lengths and be arranged in the form of a general square.

FIG. 10 shows a further embodiment of the invention. The combination of two positioning units 10a, 10b each having a carriage 3a, 3b and a respective linear drive 1a, 1 b for compensating for temperature-induced position errors is illustrated. This combination permits not only linear adjustment operations to be implemented, but also 2-dimensional movements and simultaneous temperature-induced position errors to be avoided. An additional positioning unit orthogonally with respect to the two positioning units 10a and 10b, and therefore a 3-dimensional movement and simultaneous temperature-induced position error compensation can likewise be realized.

It is a further aspect of the invention to provide a suitable temperature management for the positioning unit 10 according to the invention. The previously described aspects of the invention previously all originate from a quasi stationary state, i.e. assume that all of the components are at the same temperature. If, however, for example in the spindle 2, a temperature gradient is formed which, for example, is more probable by the attachment of the drive at one end, then a nonuniform expansion of the spindle 2 occurs.

In the embodiments illustrated in FIGS. 3 to 10, in addition to the provision of a compensation structure 11, the specific aspect of thermal insulation and thermal coupling opposes the effect of the inhomogeneous temperature distribution in the components. The components which are responsible for the position of the carriage 3 along its movement direction, i.e. the spindle 2, the nut 7, the bearings 18a, 18b, the joint arrangements 5a, 5b and the compensation rods 4a, 4b, 4c, 4d and/or the plates 20a, 20b, 20c, 20d, are readily thermally coupled with respect to one another and the thermal mass thereof is consciously kept low. This has the effect that heat which penetrates as far as said components is distributed rapidly and uniformly and the temperature gradients are thereby kept small. High thermal insulation is sought with respect to the surrounding components, for example the carriage 3 and the motor 23. In addition, a high thermal mass of said parts is sought. As a result, heat from diverse sources, such as, for example, the motor 23, finds its way more easily into the components not determining the position, i.e. the carriage 3, the base 16 and other structural elements. In addition, the heat flow over the boundaries into the region determining the position, the linear drive 1, the compensation rods 4a, 4b, 4c, 4d, joints 6a, 6b, etc., is small in comparison to the heat flow which provides a uniform distribution in the interior of this region. In the case of a realistic increase in temperature (for example by means of the motor drive) of 1-2° C., the spindle 2 expands by approximately 5 μm.

In the embodiment of FIGS. 8 and 10, the frame of the stepping motor 23 is connected to the carriage 3. It is likewise also conceivable to arrange the motor 23 on one of the bearing shells 17a or 17b. This approach has the advantage that the motor 23 is supported directly in the drive train and the torsional moment is not supported via the compensation rods 4a, 4b, 4c, 4d.

In the embodiment illustrated, the joints 6a, 6b and the joint arrangements 5a, 5b are realized as solid joints. The use of solid joints affords significant advantages over discrete joints. They can thus be realized in a manner free from play, and in a manner free from friction, i.e. very substantially linearly in their behavior and in a relatively small construction space. Alternatively thereto, discrete joints can also be used with plain and rolling bearings (for example ball bearings, cylinder bearings or needle bearings).

As already mentioned in the description of the figures, an arrangement in which the temperature-compensating components of the positioning unit 10 for compensating for the temperature is not part of the carriage 3, but rather part of the base 16, is likewise conceivable.

The above-described invention can also be used analogously on other linear drives. Examples thereof are:

Spindle drives, ball screw drives, for example a recirculating ball screw, roller screw drives with a roller return, planetary roller screw drives, trapezoidal screw drives, quick-acting screw drives, hydrostatic screw drives; linear motors; electromechanical cylinders, for example electric motor with spindle drive; pneumatic cylinders; hydraulic cylinders; gas-filled compression springs; rack drives; scotch-yoke crank drives, for example a crank loop; or toothed belt drives.

A further equivalent embodiment of the positioning unit 10 for compensating for temperature-induced changes in length in linear drives is also possible by means of bending rods. The bending rods can replace the compensation rods 4a, 4b, 4c, 4d and/or the joints 6a, 6b and the joint arrangements 5a, 5b. The bending rods could be designed in a curved shape or in a triangular arrangement. The change in length of the linear drive 1 would then deform the bending rods and change the curvature of the bending rods or the angle of the bending rods with respect to one another and thereby implement the principle according to the invention of the compensation for the change in length.

1-19. (canceled)

20. A positioning unit, comprising:
a linear drive having an elongate part and a short part;
a base;
a carriage being adjustable by said linear drive;
a joint;
two joint arrangements;
at least two compensation rods, wherein in each case two adjacent said compensation rods being connected to each other at a first end via said joint and being connected at a second end in each case to said elongate part of said linear drive via one of said two joint arrangements which are each disposed at an end of said elongate part of said linear drive, wherein said compensation rods and said elongate part of said linear drive are disposed in a form of a triangle, and an angle between said compensation rods is changeable at said joint by a thermal change in length of said elongate part of said linear drive; and
said carriage being connected to said joint and said short part of said linear drive is connected to said base, or said carriage is connected to said short part of said linear drive and said base is connected to said joint.

21. The positioning unit according to claim 20, wherein:
said joint is one of a plurality of joints;
said at least two compensation rods are two of four compensation rods, wherein in each case two adjacent said compensation rods are connected at said first end in each case via one of said joints and are connected at said second end in each case to said elongate part of said linear drive via one of said two joint arrangements which are each disposed at said end of said elongate part of said linear drive;
in each case said two compensation rods, which are connected via said joints, and said elongate part of said linear drive are disposed in a form of said triangle, and said angle between said two compensation rods, which are connected at said joints, is in each case changeable at said joints by the thermal change in the length of said elongate part of said linear drive;
said four compensation rods are disposed in a form of a parallelogram; and
said carriage is connected to said joints and said short part of said linear drive is connected to said base, or said carriage is connected to said short part of said linear drive and said base is connected to said joints.

22. The positioning unit according to claim 20, wherein said two compensation rods have a same length and in each case said two compensation rods, which are connected via said joint, are disposed together with said elongate part of said linear drive in a form of an isosceles triangle.

23. The positioning unit according to claim 20, wherein said two compensation rods have different lengths, and in each case said two compensation rods, which are connected via said joint, are disposed together with said elongate part of said linear drive in a form of a general triangle.

24. The positioning unit according to claim 21, wherein said joint arrangements each have at least two partial joints, wherein each of said partial joints connects said joint arrangements to one of said compensation rods each.

25. The positioning unit according to claim 24, wherein at least one of said joints, said joint arrangements or said partial joints are solid joints.

26. The positioning unit according to claim 21, wherein said joints, said joint arrangements and said linear drive are disposed in a plane, and said joints are displaceable in said plane.

27. The positioning unit according to claim 24, wherein at least one of said compensation rods, said joints or said joint arrangements are realized in duplicate for a stiffer design and in each case in every two planes, which are disposed parallel to each other, are disposed at a distance from a plane of movement of said linear drive.

28. The positioning unit according to claim 20, further comprising at least one guide, said carriage is guided in said at least one guide.

29. The positioning unit according to claim 21, wherein:
said linear drive is a spindle drive;
said elongate part is a spindle and said short part is nut moving on said spindle;
said compensation rods are each connected to one of ends of said spindle via one of said joint arrangements; and
said carriage is connected to said nut and said base is connected to said joint, or said carriage is connected to said joint and said base is connected to said nut.

30. The positioning unit according to claim 29, further comprising bearings, ends of said spindle are in each case mounted in one of said bearings on said joint arrangements.

31. The positioning unit according to claim 21, further comprising springs, wherein in each case one of said springs connects one of said joints in each case to said carriage or to said base, and/or said joints are each pretensionable by said springs.

32. The positioning unit according to claim 24, further comprising a plate, at least one of said compensation rods or said joint arrangements are integrated in said plate, and are configured as said plate, wherein at least one of said joints or said partial joints are configured as solid joints being webs connecting at least one of said compensation rods or said joint arrangements.

33. The positioning unit according to claim 32, wherein said plate is one of four plates, wherein the positioning unit is formed by two mutually parallel planes of joint structures each having two layers of said plates.

34. The positioning unit according to claim 31, wherein said springs are parallelogram shaped structures, said parallelogram structures are integrated in said compensation rods.

35. The positioning unit according to claim 33,
wherein said compensation rods have connection points in a region of said joints;
further comprising a connecting element, said connection points of a first of said compensation rods together with said connection points of a second of said compensation rods which is connected via a respective said joint are in each case connected to said carriage or to said base via said connecting element.

36. The positioning unit according to claim 20,
wherein said linear drive, said joint arrangements and said compensation rods have good thermal coupling to one another and low thermal masses;
further comprising a motor; and
wherein said carriage, said base and said motor are thermally decoupled from said linear drive, said joint arrangements and said compensation rods and have a large thermal mass in relation to masses of said linear drive, said joint arrangements and said compensation rods.

37. The positioning unit according to claim 20, wherein said linear drive is selected from the group consisting of a spindle drive and a linear motor.

38. The positioning unit according to claim 21, wherein said four compensation rods have a same length and in each case said two compensation rods, which are connected via said joint, are disposed together with said elongate part of said linear drive in a form of a parallelogram.

39. The positioning unit according to claim 21, wherein said four compensation rods have different lengths in pairs, and in each case said two compensation rods, which are connected via said joint, are disposed together with said elongate part of said linear drive in a form of a general square.

40. A positioning unit system, comprising:
two positioning units each containing:
a linear drive having an elongate part and a short part;
a base;
a carriage being adjustable by said linear drive;
a joint;
two joint arrangements;
at least two compensation rods, wherein in each case two adjacent said compensation rods being connected to each other at a first end via said joint and being connected at a second end in each case to said elongate part of said linear drive via one of said two joint arrangements which are each disposed at an end of said elongate part of said linear drive, wherein said compensation rods and said elongate part of said linear drive are disposed in a form of a triangle, and an angle between said compensation rods is changeable at said joint by a thermal change in length of said elongate part of said linear drive; and
said carriage being connected to said joint and said short part of said linear drive is connected to said base, or said carriage is connected to said short part of said linear drive and said base is connected to said joint; and
wherein directions of movement of said carriages of said linear drives run orthogonally to each other, and wherein one of said carriages is connectable to said base or to said carriage of the other positioning unit in each case.

41. The positioning unit according to claim 40, wherein:
said two positioning units are two of three positioning units, for 3-dimensional positioning, wherein said third positioning unit is disposed orthogonally to said two positioning units and is connectable to said base or to said carriage of one of said two positioning units.
